(19) United States
(12) Patent Application Publication
(10) Pub. No.: US 2025/0031609 A1
(43) Pub. Date: Jan. 30, 2025

(54) MOWING METHOD AND APPARATUS, ROBOTIC LAWN MOWER AND STORAGE MEDIUM

(71) Applicant: SHENZHEN MAMMOTION INNOVATION CO., LIMITED, Shenzhen (CN)

(72) Inventors: Pengju DU, Shenzhen (CN); Ning WANG, Shenzhen (CN); Zhenhao HUANG, Shenzhen (CN)

(73) Assignee: SHENZHEN MAMMOTION INNOVATION CO., LIMITED, Shenzhen (CN)

(21) Appl. No.: 18/911,001

(22) Filed: Oct. 9, 2024

Related U.S. Application Data
(63) Continuation of application No. PCT/CN2023/101478, filed on Jun. 20, 2023.

(30) Foreign Application Priority Data
Jun. 21, 2022 (CN) 202210709173.5

(51) Int. Cl. A01D 34/00; A01D 101/00; G05D 1/646; G05D 1/648; G05D 107/20

(52) U.S. Cl. CPC A01D 34/008; G05D 1/646; G05D 1/648; A01D 2101/00; G05D 2107/23

(57) ABSTRACT

Embodiments of the present disclosure disclose a mowing method and apparatus, a robotic lawn mower, and a storage medium. The method includes: determining a current mowing direction of a robotic lawn mower according to a historical mowing direction in response to a mowing trigger request for the robotic lawn mower, the current mowing direction being different from the historical mowing direction; obtaining a preset grass region to be mowed; generating a mowing route following parallel arcuate paths pattern for traveling in the current mowing direction based on the grass region to be mowed, and a mowing mode and the current mowing direction of the robotic lawn mower; and controlling the robotic lawn mower to perform a mowing operation based on the mowing route following parallel arcuate paths pattern.

### CROSS-REFERENCE TO RELATED APPLICATIONS

The present application is a continuation application of International Application No. PCT/CN2023/101478, filed Jun. 20, 2023, which claims the priority to Chinese Patent Application No. CN 202210709173.5, filed in the China National Intellectual Property Administration on Jun. 21, 2022 and entitled “MOWING METHOD AND APPARATUS, ROBOTIC LAWN MOWER AND STORAGE MEDIUM”, the disclosures of which are incorporated herein by reference in their entireties.

### TECHNICAL FIELD

The present disclosure relates to the field of computer technology, and particularly to a mowing method and apparatus, a robotic lawn mower and a storage medium.

### BACKGROUND ART

Robotic lawn mowers are widely used for maintenance of home courtyard lawn and trimming of large grass. The robotic lawn mowers incorporate techniques such as motion control, multi-sensor fusion, path planning, etc. In order to control a robotic lawn mower to carry out a mowing operation, a mowing path needs to be planned for the robotic lawn mower so that the robotic lawn mower can completely cover all working regions.

However, random path planning is currently employed in most of robotic lawn mowers for mowing. Missing or repetitive mowing often occurs during mowing due to the randomness of the path planning. It can be seen therefrom that the current mowing solution has a low working area coverage and a low mowing efficiency.

### SUMMARY OF THE INVENTION

1. According to a first aspect, an embodiment of the present invention provides a mowing method comprising, determining a current mowing direction of a robotic lawn mower according to a historical mowing direction in response to a mowing trigger request for the robotic lawn mower, the current mowing direction being different from the historical mowing direction; obtaining a preset grass region to be mowed; generating a mowing route following parallel arcuate paths pattern for traveling in the current mowing direction based on the grass region to be mowed, and a mowing mode and the current mowing direction of the robotic lawn mower; and controlling the robotic lawn mower to perform a mowing operation based on the mowing route following parallel arcuate paths pattern.

Optionally, generating a mowing route following parallel arcuate paths pattern along the current mowing direction based on the grass region to be mowed, and a mowing mode and the current mowing direction of the robotic lawn mower includes:
extracting a swath parameter of the robotic lawn mower from the mowing trigger request;
determining a mower turn-around point based on mowing boundaries of the grass region to be mowed, and the mowing mode, the swath parameter and the current mowing direction of the robotic lawn mower; and
generating the mowing route following parallel arcuate paths pattern for traveling in the current mowing direction according to the current mowing position and the mower turn-around point.

Optionally, in some embodiments, generating the mowing route following parallel arcuate paths pattern which the robotic lawn mower travels in the current mowing direction according to the current mowing position includes:
obtaining an isolated area in the grass region to be mowed;
determining route turning points based on the mowing mode of the robotic lawn mower, isolation boundaries of the isolated area, and the current mowing direction; and
generating the mowing route following parallel arcuate paths pattern for traveling in the current mowing direction according to the current mowing position, the route turning points and the mowing boundaries of the grass region to be mowed.

Optionally, in some embodiments, generating the mowing route following parallel arcuate paths pattern for traveling in the current mowing direction according to the current mowing position, the route turning points and the mowing boundaries of the grass region to be mowed includes:
generating a reference mowing route for traveling in the current mowing direction according to a current mowing position, the mowing mode and the mowing boundaries of the grass region to be mowed, the reference mowing route including a plurality of reference mowing paths;
adjusting the reference mowing paths according to the route turning points and the mowing mode so as to obtain mowing paths; and
obtaining the mowing route following parallel arcuate paths pattern along the current mowing direction by connecting the mowing paths.

Optionally, in some embodiments, the method further includes:
detecting a current operating mode;
when it is detected that the operating mode is a simplex mode, generating a mowing route following parallel arcuate paths pattern for traveling in the current mowing direction according to the current mowing position; and
when it is detected that the operating mode is a duplex mode, generating a first mowing route for traveling in the current mowing direction according to the current mowing position, and generating a second mowing route that intersects the first mowing route with an end of the first mowing route as a reference, wherein the first mowing route and the second mowing route are both mowing route following parallel arcuate paths patterns.

Optionally, in some embodiments, the direction of the first mowing route and the direction of the second mowing route are perpendicular to each other.

In a second aspect, an embodiment of the present disclosure provides a mowing method, including:
determining an initial mowing direction in response to a mowing trigger request for a robotic lawn mower;
obtaining a preset grass region to be mowed;
generating a mowing route following parallel arcuate paths pattern for traveling in the current mowing direction based on the grass region to be mowed, and a mowing mode of the robotic lawn mower and the initial mowing direction; and
controlling the robotic lawn mower to perform a mowing operation based on the mowing route following parallel arcuate paths pattern.

In a third aspect, an embodiment of the present application provides a mowing apparatus, including:
a determination circuit for determining a current mowing direction of a robotic lawn mower according to a historical mowing direction in response to a mowing trigger request for the robotic lawn mower, the current mowing direction being different from the historical mowing direction;
an obtaining circuit for obtaining a preset grass region to be mowed;
a generation circuit for generating a mowing route following parallel arcuate paths pattern for traveling in the current mowing direction based on the grass region to be mowed, and a mowing mode and the current mowing direction of the robotic lawn mower; and
a control circuit for controlling the robotic lawn mower to perform a mowing operation based on the mowing route following parallel arcuate paths pattern.

In a fourth aspect, an embodiment of the present application provides a mowing apparatus, including:
a determination circuit for determining an initial mowing direction in response to a mowing trigger request for a robotic lawn mower;
an obtaining circuit for obtaining a preset grass region to be mowed;
a generation circuit for generating a mowing route following parallel arcuate paths pattern for traveling in the current mowing direction based on the grass region to be mowed, and a mowing mode of the robotic lawn mower and the initial mowing direction; and
a control circuit for controlling the robotic lawn mower to perform a mowing operation based on the mowing route following parallel arcuate paths pattern.

### BRIEF DESCRIPTION OF THE DRAWINGS

In order to more clearly describe the technical solutions in the embodiments of the present disclosure, the accompanying drawings necessary for describing the embodiments will be briefly described below. Apparently, the accompanying drawings in the description below merely show some of the embodiments of the present disclosure, and those skilled in the art would have obtained other drawings from these drawings without involving any inventive effort.

FIG. 1A is a schematic view of a scenario of a mowing method according to an embodiment of the present disclosure;

FIG. 1B is a schematic flowchart of a mowing method according to an embodiment of the present disclosure;

FIGS. 1C-1H are schematic diagrams of a mowing route according to the present disclosure;

FIG. 2 is a schematic flowchart of another mowing method according to an embodiment of the present disclosure;

FIG. 3 is a schematic view of another scenario of the mowing method according to an embodiment of the present disclosure;

FIG. 4A is a schematic view of a configuration of a mowing apparatus according to an embodiment of the present disclosure;

FIG. 4B is a schematic view of another configuration of the mowing apparatus according to an embodiment of the present disclosure;

FIG. 5 is a schematic view of yet another configuration of the mowing apparatus according to an embodiment of the present disclosure; and

FIG. 6 is a schematic diagram of a configuration of an electronic device according to an embodiment of the present disclosure.

### DETAILED DESCRIPTION OF EMBODIMENTS

The technical solutions in the embodiments of the present disclosure will be described clearly and completely below with reference to the accompanying drawings in the embodiments of the present disclosure. Apparently, the described embodiments are only some rather than all of the embodiments of the present disclosure. All the other embodiments obtained by those skilled in the art based on the embodiments of the present disclosure without creative efforts shall fall within the scope of protection of the present disclosure.

It should be noted that when an element is referred to as being “fixed to” or “disposed” on another element, it may be directly on or indirectly on another element. When an element is referred to as being “connected” to another element, it may be directly or indirectly connected to another element. In addition, the connection may have the function of fixing or circuit connection.

It should be understood that the orientation or positional relationships indicated by the terms “length”, “width”, “upper”, “lower”, “front”, “rear”, “left”, “right”, “vertical”, “horizontal”, “top”, “bottom”, “inner”, “outer”, etc. are based on the orientation or positional relationship shown in the accompanying drawings and are only for facilitating the description of the embodiments of the present disclosure and simplifying the description, rather than indicating or implying that an apparatus or an element referred to must have a particular orientation or be constructed and operated in a particular orientation, and therefore will not be interpreted as limiting the present invention.

In addition, the terms “first” and “second” are merely used for the purpose of illustration, and cannot be construed as indicating or implying relative importance or implicitly indicating the number of technical features indicated. Thus, the features defined with “first” and “second” may explicitly or implicitly include one or more features. In the description of the embodiments of the present disclosure, “a plurality of” means two or more, unless specifically defined otherwise.

The embodiments of the present disclosure provide a mowing method and apparatus, a robotic lawn mower and a storage medium.

The mowing apparatus may be integrated particularly in a microcontroller unit (MCU) of a robotic lawn mower, or integrated in an intelligent terminal or server. The MCU, also referred as a single-chip microcomputer or microcontroller, is designed to reduce the frequency and specifications of a central process unit (CPU) and integrates peripheral interfaces such as a memory, a timer, a USB, an analog to digital converter/digital to analog converter, a UART, a PLC and a DMA to form a chip-level computer so as to provide different combined controls for different disclosures. The robotic lawn mower may walk automatically, prevent collisions, return for charging automatically within a range, is provided with safety detection and battery level detection, and has a certain climbing ability, is especially suitable for lawn trimming and maintenance in places such as home courtyards, public green space, etc., and has the characteristics of automatic grass cutting, cleanup of grass chips, automatic rain protection, automatic charging, automatic obstacle avoidance, small form factor, electronic virtual fencing, network control, etc.

The terminal may be a smartphone, a tablet, a laptop, a desktop computer, a smart speaker, a smart watch, etc., but not limited to those. The terminal and the server may be connected directly or indirectly by means of wired or wireless communication, the server may be a separate physical server, a cluster or distributed system of multiple physical servers, or a cloud server which provides cloud services, cloud databases, cloud computing, cloud functions, cloud storage, network services, cloud communications, middleware services, domain name services, security services, CDNs and basic cloud computing services such as big data and artificial intelligence platforms, and is not limited in the present disclosure.

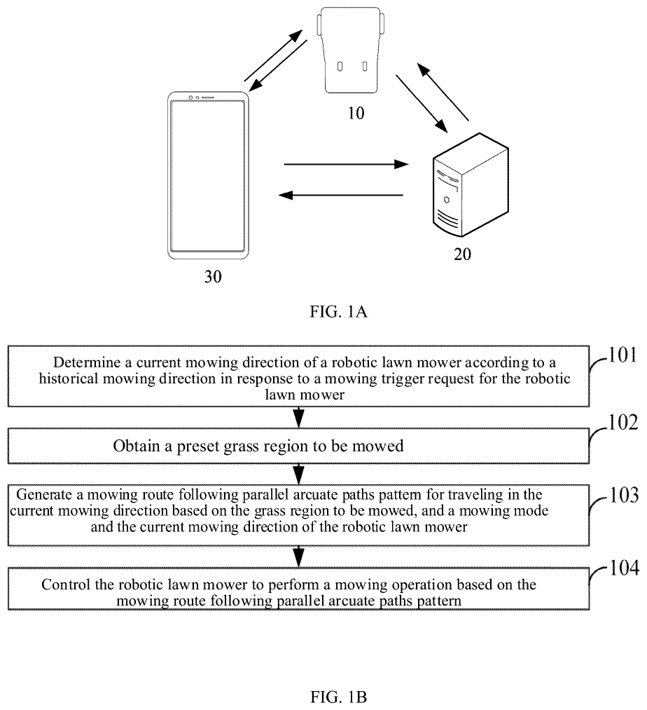

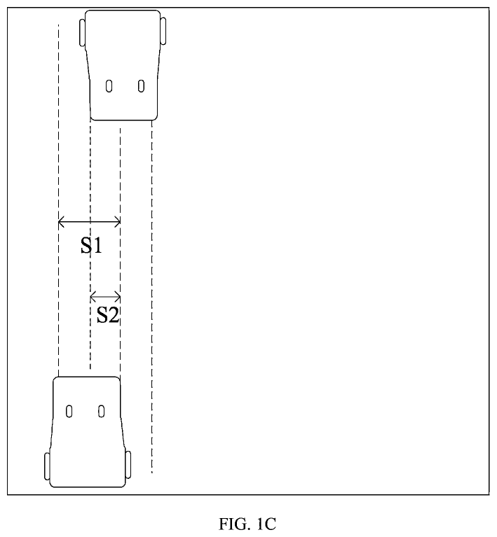

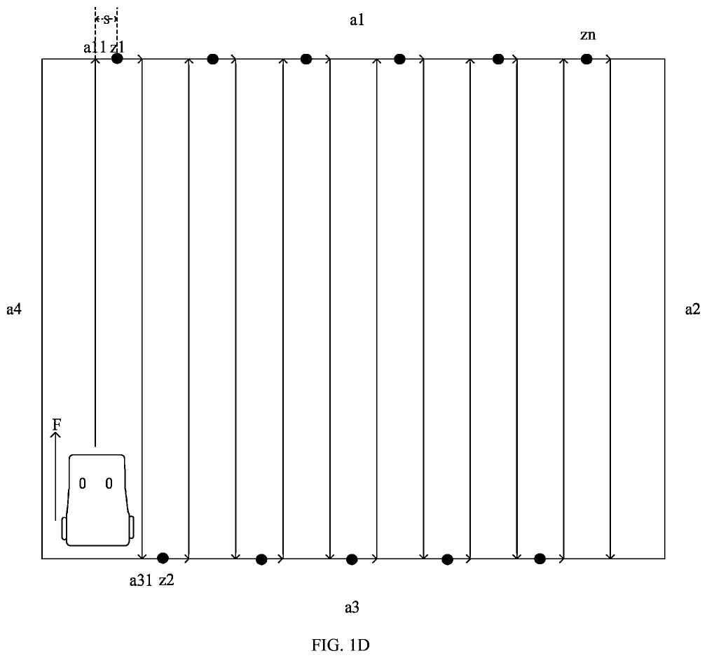

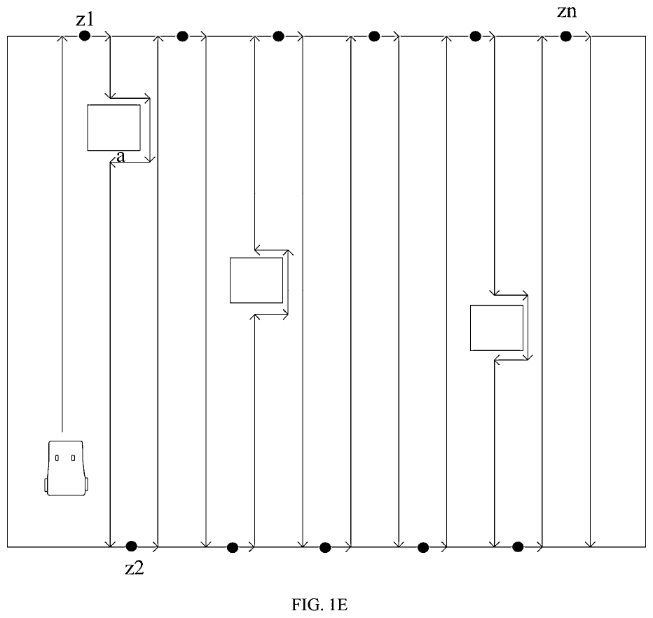

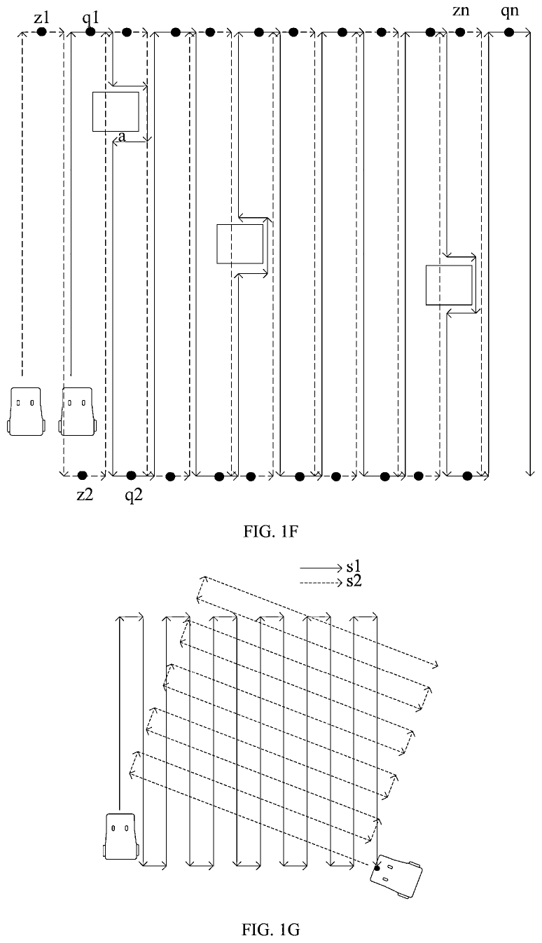

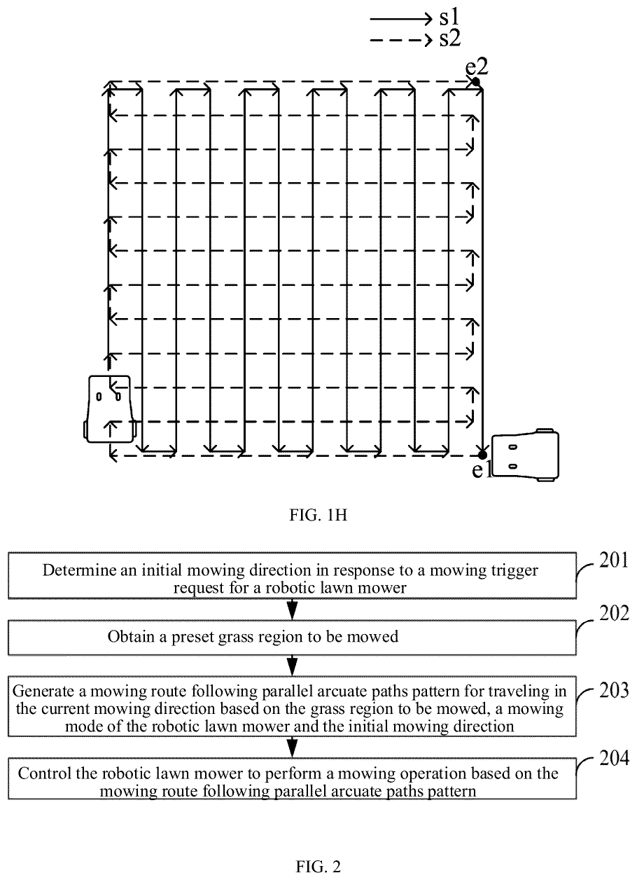

For example, referring to FIG. 1A, the present disclosure provides a mowing system, including a robotic lawn mower 10, a server 20 and a user device 30 which are in communication connection with one another. A user may control a movement of the robotic lawn mower 10 in advance by the user device 30, set a grass region to be mowed based on a movement trajectory, and synchronize data corresponding to the grass region to be mowed into the robotic lawn mower 10 and the server 20, and historical mowing data corresponding to historical mowing tasks are also recorded in the robotic lawn mower 10. Optionally, in some embodiments, in order to reduce the storage burden on the robotic lawn mower 10, after each mowing is completed, the robotic lawn mower 10 may upload the historical mowing data to the server 20. The server 20 may send the historical mowing data to the robotic lawn mower 10 when a mowing task is performed. Then, after a corresponding mowing route is generated in the robotic lawn mower 10, local historical mowing data is deleted.

For example, particularly, the robotic lawn mower 10 obtains a historical mowing direction corresponding to a mowing trigger request in response to the mowing trigger request, and then determines a current mowing direction of the robotic lawn mower 10 according to the historical mowing direction, wherein the historical mowing direction is different from the current mowing direction. Next, a preset grass region to be mowed is obtained, and as previously described, the grass region to be mowed is preset by the user by means of the user device 30. The robotic lawn mower 10 may obtain the grass region to be mowed locally. Then, the robotic lawn mower 10 generates a mowing route following parallel arcuate paths pattern for traveling in the current mowing direction based on the grass region to be mowed, and the mowing mode and the current mowing direction of the robotic lawn mower 10. Finally, the robotic lawn mower 10 is controlled to perform a mowing operation based on the mowing route following parallel arcuate paths pattern, that is, the robotic lawn mower 10 performs the mowing operation according to the mowing route following parallel arcuate paths pattern.

In the mowing solution provided by the present disclosure, the current mowing direction that is different from the historical mowing direction is determined such that the cutting height of the lawn is flatter, avoiding the problem of multiple repetitive mowing routes impairing the lawn. In addition, a mowing route following parallel arcuate paths pattern is generated based on the grass region to be mowed, the mowing mode and the current mowing direction, the robotic lawn mower is subsequently controlled according to the mowing route following parallel arcuate paths pattern to perform the mowing operation, which can reduce the problem of missing mowing. It can be seen therefrom that the embodiments of the present disclosure can increase the coverage of the working area and the mowing efficiency.

Detailed descriptions are provided below. It should be note that order in which the following embodiments are described is not intended to limit the order of precedence of the embodiments.

A mowing method includes determining a current mowing direction of a robotic lawn mower according to a historical mowing direction in response to a mowing trigger request for the robotic lawn mower, obtaining a preset grass region to be mowed, generating a mowing route following parallel arcuate paths pattern for traveling in the current mowing direction based on the grass region to be mowed, and a mowing mode and the current mowing direction of the robotic lawn mower, and controlling the robotic lawn mower to perform a mowing operation based on the mowing route following parallel arcuate paths pattern.

Referring to FIG. 1B, FIG. 1B is a schematic flowchart of a mowing method provided by an embodiment of the present disclosure. The mowing method may have a specific process as follows.

At step 101, a current mowing direction of a robotic lawn mower is determined according to a historical mowing direction in response to a mowing trigger request for the robotic lawn mower.

The current mowing direction is different from the historical mowing direction, the mowing trigger request may be triggered by the robotic lawn mower itself, triggered by the server, or triggered by a user by means of hardware or software. As an example, a timed operation is required for the robotic lawn mower, and the mowing trigger request is triggered within a set time. As another example, the server sends a mowing trigger request according to a reported mowing trigging instruction. The user may also input mowing task information by means of an disclosure on a mobile phone, and the mobile phone generates the mowing trigger request for the robotic lawn mower from the mowing task information.

Optionally, in some embodiments, the mowing trigger request may carry historical mowing information of the robotic lawn mower, which may include a historical mowing date, the historical mowing direction and the historical grass region to be mowed. In response to the mowing trigger request for the robotic lawn mower, the historical mowing direction is extracted from the mowing trigger request, and then the current mowing direction is determined according to the historical mowing direction, where the historical mowing direction may be the mowing direction previous to the current mowing direction, that is, the current mowing direction is a direction for the N^{th} mowing, where N is an integer greater than 2. For example, a first deflection angle is 15 degrees, and a first deflection direction is a deflection to the left, and it can be seen that the direction for the N-1^{th} mowing is deflected to the left by 15 degrees to arrive at the direction for the N^{th} mowing direction. Further, the current mowing direction may also be determined with reference to the number of times of historical mowing, that is to say, optionally, the step of determining the current mowing direction of the robotic lawn mower according to the historical mowing direction in response to the mowing trigger request for the robotic lawn mower may particularly includes:
(11) obtaining a preset deflection strategy and the number of times of historical mowing;
(12) calculating a target deflection angle based on the historical mowing information and the first deflection angle; and
(13) determining the direction for the N^{th} mowing by the robotic lawn mower based on the first deflection direction, the target deflection angle and the direction for the N-1^{th} mowing.

The deflection strategy carries the first deflection direction and the first deflection angle, and the historical mowing information carries the number of times of historical mowing and a historical deflection angle. In order to avoid that a route for the N^{th} mowing that is generated subsequently is the same as the route for the N−1^{th} mowing, which resulting in excessive trimming of the lawn at the same position in the grass region to be mowed, which in turn impairs the lawn, in the present disclosure, the first deflection direction, the first deflection angle and the direction for the N−1^{th} mowing are used to determine the direction for the N^{th} mowing by the robotic lawn mower.

Optionally, the first deflection angle may be a fixed value or a random value. For example, the first deflection angle is a fixed value and the first deflection angle is 15°, the first deflection direction is a deflection to the left, and the number of times of historical mowing is 11, and the historical deflection angle is 165°, that is, the direction for the N−1^{th} mowing differs from the direction for the first mowing by 165°. It is can be seen that the mowing direction determined based on the first deflection angle at this time is opposite to an initial mowing direction, resulting in an irrational route planed subsequently, and missing or repetitive mowing thus occurs. Therefore, in the present disclosure, if the number of times of historical mowing is greater than or equal to a preset value, a relationship between the target deflection angle t and the first deflection angle a is: t=90°−a, that is, in this example, the target deflection angle is 75°. It should also be noted that if the number of times of historical mowing is greater than or equal to the preset value, an opposite direction to the first deflection direction is taken as the target deflection direction, that is, the direction for the N−1^{th} mowing is deflected to the right by 75 degrees to arrive at the direction for the N^{th} mowing.

As another example, the first deflection angle is a random value, the first deflection value is 5°, the first deflection direction is a deflection to the left, the number of times of historical mowing is 4, the historical deflection angle is 55°, and an angle difference between the directions for the fourth mowing and for the third mowing is 5°. Taking a certain volume of a cutter disc of the robotic lawn mower into consideration, in order to avoid repetitive cutting of a piece of grass in subsequent planning, in the present disclosure, when the first deflection angle corresponding to the direction for the N^{th} mowing is the same as the first deflection angle corresponding to the direction for the N−1^{th} mowing, the relationship between the target deflection angle t and the first deflection angle a is: t=2a, from which the target deflection angle corresponding to the direction for the N^{th} mowing can be obtained.

It should also be noted that if the historical mowing direction is the initial mowing direction, the historical mowing direction is a reference, the current mowing direction is determined based on the deflection direction and the deflection angle, that is, optionally, in some embodiments, the step of determining the current mowing direction of the robotic lawn mower according to the historical mowing direction in response to the mowing trigger request for the robotic lawn mower may particularly include:
(21) obtaining a preset deflection strategy; and
(22) determining the current mowing direction of the robotic lawn mower based on the second deflection direction, the second deflection angle and the initial mowing direction.

Optionally, the deflection strategy carries the second deflection direction and the second deflection angle. For particular determination of the current mowing direction of the robotic lawn mower, reference may be made to the foregoing embodiment, which will not be described here again.

At step 102, a preset grass region to be mowed is obtained.

The grass region to be mowed may be an area encircled beforehand by the user in a mowing map, or may be determined from differential positioning data and satellite positioning data of the robotic lawn mower, and particularly may be determined according to actual situations. The number of grass region to be mowed can be one or more, and the shape and dimension of the grass region to be mowed can be preset by the user.

For example, a mowing map corresponding to the robotic lawn mower is determined from the satellite positioning data, and the grass region to be mowed is then identified in the mowing map in response to a region identification operation for the mowing map.

At step 103, a mowing route following parallel arcuate paths pattern for traveling in the current mowing direction is generated based on the grass region to be mowed, and the mowing mode and the current mowing direction of the robotic lawn mower.

The mowing mode of the robotic lawn mower may be preset by operation and maintenance personnel or by the user. Different mowing modes correspond to different swaths, cutting shapes and travel speeds of the robotic lawn mower. In the present disclosure, the swath refers to the mowing width of the robotic lawn mower, i.e., the width over which the cutter disc of the robotic lawn mower carries out cutting. Further, the mowing route following parallel arcuate paths pattern of the present disclosure includes a plurality of mowing paths, where adjacent mowing paths have an overlap therebetween. That is, it will be understood that the swath of the present disclosure refers to twice the cutting width S1 of the cutter disc minus the area of the overlap S2, i.e. the swath=2S1-S2, as shown in FIG. 1C.

Optionally, in some embodiments, the step of generating a mowing route following parallel arcuate paths pattern for traveling in the current mowing direction based on the grass region to be mowed, and the mowing mode and the current mowing direction of the robotic lawn mower includes:
(31) extracting a swath parameter of the robotic lawn mower from the mowing trigger request;
(32) determining a mower turn-around point based on mowing boundaries of the grass region to be mowed, and the mowing mode, the swath parameter and the current mowing direction of the robotic lawn mower; and
(33) generating a mowing route following parallel arcuate paths pattern for traveling in the current mowing direction according to a current mowing position.

In order for a subsequently generated mowing route to be a mowing route following parallel arcuate paths pattern, it is necessary to determine a corresponding mower turn-around point after extracting the swath parameter of the robotic lawn mower from the mowing trigger request, so as to subsequently generate a mowing route following parallel arcuate paths pattern.

For example, referring to FIG. 1D, it is determined that the mowing boundaries of the grass region to be mowed include a boundary a1, a boundary a2, a boundary a3 and a boundary a4, a current mowing mode is a parallel arcuate paths mowing mode, and the swath parameter is X. An intersection point between the robotic lawn mower and each of the mowing boundaries as the robotic lawn mower travels in the current mowing direction is determined according to the current mowing direction F and the current mowing position, and a target distance S by which the robotic lawn mower travels along the boundaries is then calculated based on the swath parameter X. For example, as shown in FIG. 1D, an intersection point a11 between the robotic lawn mower and the boundary a1 as the robotic lawn mower travels in the current mowing direction F is determined, the target distance S by which the robotic lawn mower travels to the right along the boundary a1 is calculated based on the swath parameter X. Thereby, it is possible to determine that a mower turn-around point z1 is located at the target distance S by which the intersection point a11 translates to the right, and the next mower turn-around point z2 is then calculated. After all mower turn-around points are determined, a mowing route following parallel arcuate paths pattern z1-z2- . . . -zn in the current mowing direction is generated based on the current mowing position. It should be noted that the mowing route z1-z2 refers to a route that runs from the current mowing position of the robotic lawn mower to the intersection point a11 between the robotic lawn mower and the boundary a1, then runs from the intersection point a11 to the turn-around point z1, and then runs from the turn-around point z1 to an intersection point a31 between the robotic lawn mower and the boundary a3, and finally runs from the intersection point a31 to a turn-around point z2. The route z2- . . . -zn is similar to the route z1-z2 and will not be described here.

It is to be noted that in the grass region to be mowed there may also be provided an isolated area in which mowing is not allowed and which may be set by the user according to his/her own needs. For example, referring to FIG. 1E, a plurality of isolated areas a are provided in the grass region to be mowed A. When a mowing route following parallel arcuate paths pattern is generated, it is required to bypass the isolated areas a, that is, optionally, in some embodiments, the step of generating a mowing route following parallel arcuate paths pattern for traveling in the current mowing direction according to a current mowing position may particularly includes:
(41) obtaining an isolated area in the grass region to be mowed;
(42) determining route turning points based on the mowing mode of the robotic lawn mower, isolation boundaries of the isolated area, and the current mowing direction; and
(43) generating a mowing route following parallel arcuate paths pattern for traveling in the current mowing direction according to the current mowing position, the route turning points and the mowing boundaries of the grass region to be mowed.

With continued reference to FIG. 1E, during path planning, route turning points at which turning operations are required when the robotic lawn mower passes by the isolated area a are determined based on the mowing shape corresponding to the mowing mode, the isolation boundaries of the isolated area and the current mowing direction. Particularly, the dimension information of the robotic lawn mower may be obtained, and route turning points at which turning operations are required when the robotic lawn mower passes by the isolated area a are estimated based on the dimension information in combination with the mowing shape corresponding to the mowing mode, the isolation boundaries of the isolated area and the current mowing direction, whereby a route turning point is obtained. Finally, a mowing route following parallel arcuate paths pattern along the current mowing direction is generated according to the current mowing position, the route turning points and the mowing boundaries of the grass region to be mowed.

Further, a reference mowing route may also be generated in advance, the reference mowing route is adjusted by means of the route turning point so as to generate the mowing route following parallel arcuate paths pattern. That is, optionally, in some embodiments, the step of generating a mowing route following parallel arcuate paths pattern for traveling in the current mowing direction according to the current mowing position, the route turning points and the mowing boundaries of the grass region to be mowed may particularly include:
(51) generating a reference mowing route along the current mowing direction according to the current mowing position, the mowing mode, and the mowing boundaries of the grass region to be mowed;
(52) adjusting the reference mowing paths according to the route turning points and the mowing mode so as to obtain mowing paths; and
(53) obtaining a mowing route following parallel arcuate paths pattern along the current mowing direction by connecting the mowing paths.

For example, particularly, referring to FIG. 1F, the reference mowing route q1-q2-. . . -qn includes a plurality of reference mowing paths, such as a reference mowing path q1-q2 and a reference mowing path q2-q3. The reference mowing route q1-q2- . . . -qn along which the robotic lawn mower travels in the current mowing direction may be generated according to the current mowing position, the mowing mode and the mowing boundaries of the grass region to be mowed. For a particular planning method, reference may be made to the foregoing embodiments. Then, reference mowing paths corresponding to the route turning points are determined, and the reference mowing paths are adjusted based on the mowing shape corresponding to the mowing mode such that the adjusted reference mowing paths bypass the isolated areas a, and finally, a mowing route following parallel arcuate paths pattern along the current mowing direction is obtained by connecting the mowing paths.

Optionally, in some embodiments, operating modes of the robotic lawn mower may include a simplex mode and a duplex mode. It may be understood that in the simplex mode, the robotic lawn mower plans only one mowing route within the grass region to be mowed, and in the duplex mode, the robotic lawn mower plan only two mowing routes within the grass region to be mowed.

Optionally, in the duplex mode, two different mowing routes are planned, thereby increasing the coverage of the mowing area, that is, the mowing method of the present disclosure may particularly further include:
(61) detecting a current operating mode;
(62) when it is detected that the operating mode is the simplex mode, generating a mowing route following parallel arcuate paths pattern for traveling in the current mowing direction according to a current mowing position; and
(63) when it is detected that the operating mode is the duplex mode, generating a first mowing route for traveling in the current mowing direction according to the current mowing position, and generating a second mowing route that intersects the first mowing route with an end of the first mowing route as a reference.

When it is detected that the operating mode is the simplex mode, a mowing route following parallel arcuate paths pattern along the current mowing direction is generated according to the current mowing position, and reference may be made to the foregoing embodiments for details, which will not be repeated here.

In addition, referring to FIG. 1G, when it is detected that the operating mode is the duplex mode, a first mowing route s1 along which the robotic lawn mower travels in the current mowing direction is generated according to the current mowing position, and a second mowing route s2 that intersects the first mowing route s1 with an end e of the first mowing route s1 as a starting point of the second mowing route is then generated, where the first and second mowing routes s1, s2 are both mowing route following parallel arcuate paths patterns, and reference may be made to the foregoing embodiments for the method for planning the first and second mowing routes s1, s2, which will not be repeated here.

Optionally, in some embodiments, the direction of the first mowing route and the direction of the second mowing route are perpendicular to each other.

Referring to FIG. 1H, a first direction X and a second direction Y that are perpendicular to each other are defined. For example, after a first parallel arcuate paths mowing is completed in the first direction X, that is, after the first parallel arcuate paths mowing is completed according to the first mowing route s1, a second parallel arcuate paths mowing operation is performed in the second direction with the end e1 of the first mowing route s1 as the starting point of the second mowing route s2, such that a “cross” mowing scheme is implemented in combination with the first parallel arcuate paths mowing. Alternatively, after a first parallel arcuate paths mowing is completed in the second direction Y, that is, after the first parallel arcuate paths mowing is completed according to the second mowing route s2, a second parallel arcuate paths mowing operation is performed in the first direction with the end e2 of the second mowing route s2 as the starting point of the first mowing route s1, such that a “cross” mowing scheme is implemented in combination with the first parallel arcuate paths mowing.

At step 104, the robotic lawn mower is controlled to perform a mowing operation based on the mowing route following parallel arcuate paths pattern.

As an example, the server may control the robotic lawn mower to travel according to the mowing route following parallel arcuate paths pattern so as to perform the mowing operation. As another example, the intelligent terminal may control the robotic lawn mower to travel according to the mowing route following parallel arcuate paths pattern so as to perform the mowing operation. As yet another example, the MCU of the robotic lawn mower can control the robotic lawn mower to perform the mowing operations based on the mowing route following parallel arcuate paths pattern, that is, the robotic lawn mower performs the mowing operation according to the mowing route following parallel arcuate paths pattern.

In the embodiment of the present disclosure, a current mowing direction of a robotic lawn mower is determined according to a historical mowing direction in response to a mowing trigger request for the robotic lawn mower, where the current mowing direction is different from the historical mowing direction, then a preset grass region to be mowed is obtained, and then a mowing route following parallel arcuate paths pattern for traveling in the current mowing direction is generated based on the grass region to be mowed, and the mowing mode and the current mowing direction of the robotic lawn mower, and finally the robotic lawn mower is controlled to perform the mowing operations based on the mowing route following parallel arcuate paths pattern. In the mowing solution provided by the present disclosure, the current mowing direction that is different from the historical mowing direction is determined such that the cutting height of the lawn is flatter, avoiding the problem of multiple repetitive mowing routes impairing the lawn. In addition, a mowing route following parallel arcuate paths pattern is generated based on the grass region to be mowed, the mowing mode and the current mowing direction, the robotic lawn mower is subsequently controlled according to the mowing route following parallel arcuate paths pattern to perform the mowing operation, which can reduce the problem of missing mowing. It can be seen therefrom that the embodiments of the present disclosure can increase the coverage of the working area and the mowing efficiency.

Referring to FIG. 2, FIG. 2 is a schematic flowchart of another mowing method provided by an embodiment of the present disclosure. The mowing method may have a specific process as follows.

At step 201, an initial mowing direction is determined in response to a mowing trigger request for a robotic lawn mower.

The initial mowing direction is a direction for initial mowing by the robotic lawn mower, and no historical data is created in the robotic lawn mower. The initial mowing direction may be a preset mowing direction or a random mowing direction, and may be particularly selected according to actual situations. In addition, the intelligent terminal, the server or the robotic lawn mower may determine the initial mowing direction in response to the mowing trigger request for the robotic lawn mower, and reference may be made to the foregoing embodiments for details.

At step 202, a preset grass region to be mowed is obtained.

Reference may be made to the related descriptions of the foregoing embodiments for particular embodiments in which the preset grass region to be mowed is obtained, which will not be repeated here.

At step 203, a mowing route following parallel arcuate paths pattern for traveling in the current mowing direction is generated based on the grass region to be mowed, a mowing mode of the robotic lawn mower and the initial mowing direction.

The intelligent terminal, the server or the robotic lawn mower can generate the mowing route following parallel arcuate paths pattern, for particular embodiments of which, reference may be made to the related descriptions of the foregoing embodiments, which will not be repeated here.

At step 204, the robotic lawn mower is controlled to perform a mowing operation based on the mowing route following parallel arcuate paths pattern.

For particular embodiments in which the mowing operation is made, reference may be made to the related descriptions of the foregoing embodiments, which will not be repeated here.

In the embodiment of the present disclosure, an initial mowing direction is determined in response to a mowing trigger request for a robotic lawn mower, then a preset grass region to be mowed is obtained, and then a mowing route following parallel arcuate paths pattern for traveling in the current mowing direction is generated based on the grass region to be mowed, and the mowing mode of the robotic lawn mower and the initial mowing direction, and finally the robotic lawn mower is controlled to perform the mowing operation based on the mowing route following parallel arcuate paths pattern. In the mowing solution provided by the present disclosure, a mowing route following parallel arcuate paths pattern is generated based on the grass region to be mowed, the mowing mode and the initial mowing direction, and the robotic lawn mower is subsequently controlled according to the mowing route following parallel arcuate paths pattern to perform the mowing operation, which can reduce the problem of missing mowing. It can be seen therefrom that the embodiments of the present disclosure can increase the coverage of the working area and the mowing efficiency.

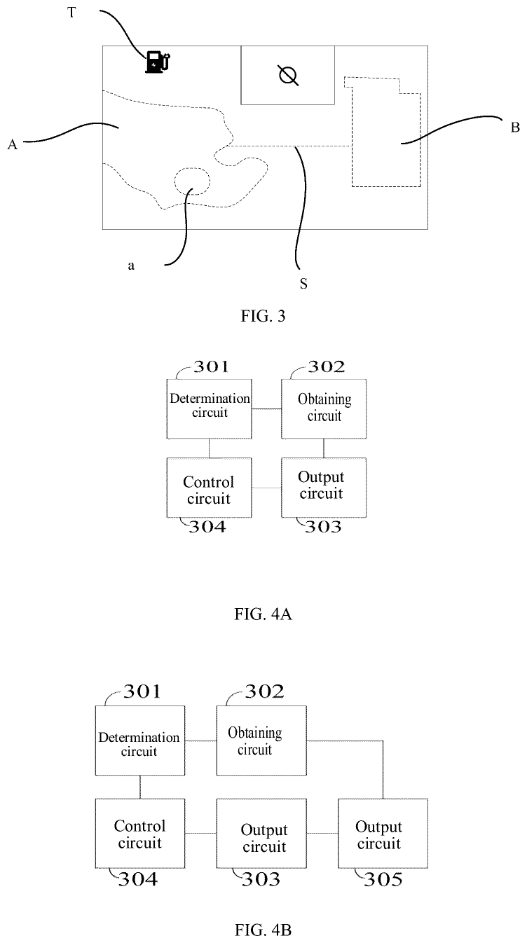

In order to provide further understanding of the mowing method of the present disclosure, further descriptions are provided by way of example of a scenario of intelligent mowing. Referring to FIG. 3, a grass region to be mowed A and a grass region to be mowed B are included in the mowing map. The grass region to be mowed A and the grass region to be mowed B are connected by a connecting path S, and a charging pile T is configured for charging the robotic lawn mower C. Before the robotic lawn mower C performs mowing, it is necessary for the user to encircle the grass region to be mowed A and the grass region to be mowed B in the mowing map in advance by means of an disclosure, and after encircling the grass region to be mowed A and the grass region to be mowed B, the robotic lawn mower C can be switched in a “path-connected” mode in which the robotic lawn mower is controlled by the disclosure to plan the connecting path S so as to connect the grass region to be mowed A to the grass region to be mowed B.

Furthermore, for known obstacles in the grass region to be mowed, it is likewise possible to control the robotic lawn mower C by means of the disclosure to delimit the obstacles, and the area is identified as an isolated area after the encircling is completed, such as an isolated area a in the grass region to be mowed A. For example, a flower area within the grass region to be mowed is encircled as an isolated area, and the robotic lawn mower C may be prohibited from entering the isolated area a during an operation.

Next, the mowing direction of the robotic lawn mower C can be determined, and then a parallel arcuate paths route plan is made to bypass the isolated area a in the grass region to be mowed A (i.e., generating a mowing route following parallel arcuate paths pattern). This allows the robotic lawn mower C to perform the mowing operation with the isolated area a in the grass region to be mowed A bypassed.

It is to be noted that upon that the operation in the grass region to be mowed A is completed, the robotic lawn mower C enters the grass region to be mowed B through the connecting path S to perform a subsequent mowing operation. When the robotic lawn mower C is moving in the connecting path S, a mowing function is switched off to prevent damages to a surface in the connecting path S.

In order to better implementing the mowing method of the embodiment of the present disclosure, an embodiment of the present disclosure further provides a mowing apparatus based on the foregoings. The terms have the same meaning as those in the above-mentioned mowing method, and for detailed implementation details, reference may be made to the descriptions of the embodiments of the method.

Referring to FIG. 4A, FIG. 4A is a schematic view of a configuration of a mowing apparatus provided in an embodiment of the present disclosure, where the mowing apparatus may include a determination circuit 301, an obtaining circuit 302, a generation circuit 303 and a control circuit 304 which may be particularly provided as follows.

The determination circuit 301 is configured to determine a current mowing direction of a robotic lawn mower according to a historical mowing direction in response to a mowing trigger request for the robotic lawn mower.

The current mowing direction is different from the historical mowing direction, the mowing trigger request may be triggered by the robotic lawn mower itself, triggered by the server, or triggered by a user by means of hardware or software. As an example, a timed operation is required for the robotic lawn mower, and the mowing trigger request is triggered within a set time. As another example, the server sends a mowing trigger request according to a reported mowing trigging instruction. The user may also input mowing task information by means of an disclosure on a mobile phone, and the mobile phone generates a mowing trigger request for the robotic lawn mower from the mowing task information.

Optionally, in some embodiments, the current mowing direction is a direction for the N^{th} mowing, where N is an integer greater than 2. The determination circuit 301 may be configured in particular to: obtain a preset deflection strategy and the number of times of historical mowing; calculate a target deflection angle based on the number of times of historical mowing and a first deflection angle; and determine the direction for the N^{th} mowing by the robotic lawn mower based on the first deflection direction, the target deflection angle and the direction for the N−1^{th} mowing.

Optionally, in some embodiments, the determination circuit 301 may be configured in particular to: obtain a preset deflection strategy; and determine the current mowing direction of the robotic lawn mower based on the second deflection direction, the second deflection angle and the initial mowing direction.

The obtaining circuit 302 is configured to obtain a preset grass region to be mowed.

The grass region to be mowed may be a region encircled beforehand by the user in a mowing map, or may be determined from differential positioning data and satellite positioning data of the robotic lawn mower, and particularly may be determined according to actual situations. The number of grass region to be moweds can be one or more, and the shape and dimension of the grass region to be mowed can be preset by the user.

The generation circuit 303 is configured to generate a mowing route following parallel arcuate paths pattern for traveling in the current mowing direction based on the grass region to be mowed, and the mowing mode and the current mowing direction of the robotic lawn mower.

The mowing mode of the robotic lawn mower may be preset by operation and maintenance personnel or by the user, and the mowing route following parallel arcuate paths pattern of the present disclosure includes a plurality of mowing paths, where there is an overlap between adjacent mowing paths.

Optionally, in some embodiments, the generation circuit 303 may particularly include:
an extraction unit for extracting a swath parameter of the robotic lawn mower from the mowing trigger request;
a determination unit for determining a mower turn-around point based on mowing boundaries of the grass region to be mowed, and the mowing mode, the swath parameter and the current mowing direction of the robotic lawn mower; and
a generation unit for generating a mowing route following parallel arcuate paths pattern for traveling in the current mowing direction according to a current mowing position.

Optionally, in some embodiments, the generation unit may particularly include:
an obtaining subunit for obtaining an isolated area in a grass region to be mowed;
a determination subunit for determining a route turning point based on the mowing mode of the robotic lawn mower, isolation boundaries of the isolated area, and the current mowing direction; and
a generation subunit for generating a mowing route following parallel arcuate paths pattern along the current mowing direction based on the current mowing position, the route turning points and the mowing boundaries of the grass region to be mowed.

Optionally, in some embodiments, the generation subunit may be configured in particular to: generate a reference mowing route for traveling in the current mowing direction according to the current mowing position, the mowing mode, and the mowing boundaries of the grass region to be mowed; adjust reference mowing paths according to the route turning points and the mowing mode so as to obtain mowing paths; and obtain a mowing route following parallel arcuate paths pattern along the current mowing direction by connecting the mowing paths.

Optionally, in some embodiments, referring to FIG. 4B, the mowing apparatus of the present disclosure may further particularly include a detection circuit 305. The detection circuit 305 may be configured in particular to: detect a current operating mode; when it is detected that the operating mode is the simplex mode, generate a mowing route following parallel arcuate paths pattern for traveling in the current mowing direction according to a current mowing position; and when it is detected that the operating mode is the duplex mode, generate a first mowing route for traveling in the current mowing direction according to the current mowing position, and generate a second mowing route that intersects the first mowing route with an end of the first mowing route as a reference.

The control circuit 304 is configured to control the robotic lawn mower to perform the mowing operation based on the mowing route following parallel arcuate paths pattern.

In the embodiment of the present disclosure, the determination circuit 301 determines a current mowing direction of a robotic lawn mower according to a historical mowing direction in response to a mowing trigger request for the robotic lawn mower, where the current mowing direction is different from the historical mowing direction, then the obtaining circuit 302 obtains a preset grass region to be mowed, and then the generation circuit 303 generates a mowing route following parallel arcuate paths pattern for traveling in the current mowing direction based on the grass region to be mowed, and the mowing mode and the current mowing direction of the robotic lawn mower, and finally the control circuit 304 controls the robotic lawn mower to perform the mowing operation based on the mowing route following parallel arcuate paths pattern. In the mowing solution provided by the present disclosure, the current mowing direction that is different from the historical mowing direction is determined such that the cutting height of the lawn is flatter, avoiding the problem of multiple repetitive mowing routes impairing the lawn. In addition, a mowing route following parallel arcuate paths pattern is generated based on the grass region to be mowed, the mowing mode and the current mowing direction, the robotic lawn mower is subsequently controlled according to the mowing route following parallel arcuate paths pattern to perform the mowing operation, which can reduce the problem of missing mowing. It can be seen therefrom that the embodiment of the present disclosure can increase the coverage of the working area and the mowing efficiency.

Referring to FIG. 5, FIG. 5 is a schematic view of a configuration of a mowing apparatus provided in an embodiment of the present disclosure, where the mowing apparatus may include a determination circuit 401, an obtaining circuit 402, a generation circuit 403 and a control circuit 404 which may be particularly provided as follows.

The determination circuit 401 is configured to determine an initial mowing direction in response to a mowing trigger request for a robotic lawn mower.

The initial mowing direction is a direction for initial mowing by the robotic lawn mower, and no historical data is created in the robotic lawn mower. The initial mowing direction may be a preset mowing direction or a random mowing direction, and may be particularly selected according to actual situations. In addition, the intelligent terminal, the server or the robotic lawn mower may determine the initial mowing direction in response to the mowing trigger request for the robotic lawn mower, and reference may be made to the foregoing embodiments for details.

The obtaining circuit 402 is configured to obtain a preset grass region to be mowed.

Reference may be made to the related descriptions of the foregoing embodiments for particular embodiments in which the preset grass region to be mowed is obtained, which will not be repeated here.

The generation circuit 403 is configured to generate a mowing route following parallel arcuate paths pattern for traveling in the current mowing direction based on the grass region to be mowed, and a mowing mode of the robotic lawn mower and the initial mowing direction.

The intelligent terminal, the server or the robotic lawn mower can generate the mowing route following parallel arcuate paths pattern, for particular embodiments of which, reference may be made to the related descriptions of the foregoing embodiments, which will not be repeated here.

The control circuit 404 is configured to control the robotic lawn mower to perform the mowing operation based on the mowing route following parallel arcuate paths pattern.

In the embodiment of the present disclosure, the determination circuit 401 determines an initial mowing direction in response to a mowing trigger request for a robotic lawn mower, then the obtaining circuit 402 obtains a preset grass region to be mowed, and then the generation circuit 403 generates a mowing route following parallel arcuate paths pattern for traveling in the current mowing direction based on the grass region to be mowed, and the mowing mode of the robotic lawn mower and the initial mowing direction, and finally the control circuit 404 controls the robotic lawn mower to perform the mowing operation based on the mowing route following parallel arcuate paths pattern. In the mowing solution provided by the present disclosure, a mowing route following parallel arcuate paths pattern is generated based on the grass region to be mowed, the mowing mode and the initial mowing direction, and the robotic lawn mower is subsequently controlled according to the mowing route following parallel arcuate paths pattern to perform the mowing operation, which can reduce the problem of missing mowing. It can be seen therefrom that the embodiments of the present disclosure can increase the coverage of the working area and the mowing efficiency.

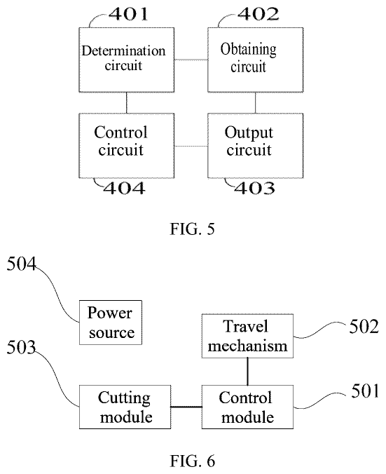

In addition, an embodiment of the present disclosure further provides a robotic lawn mower. As shown in FIG. 6, a schematic view of a configuration of the robotic lawn mower according to the embodiment of the present disclosure is shown.

Specifically, the robotic lawn mower may include components such as a control module 501, a travel mechanism 502, a cutting module 503, and a power source 504. Those skilled in the art will appreciate that the configuration of the electronic device shown in FIG. 6 does not impose a limitation on the electronic device, and may include more or fewer components than those shown, a combination of some components or a different arrangement of components.

The control module 501 is a control centre of the robotic lawn mower, the control module 501 may particularly include components such as a central process unit (CPU), a memory, an input/output port, a system bus, a timer/counter, a digital-to-analog converter and an analog-to-digital converter. The CPU performs various functions of the robotic lawn mower and processes data by running or executing software programs and/or modules stored in the memory and calling the data stored in the memory. Preferably, the CPU can integrate an disclosure processor and a modem processor, where the disclosure processor mainly processes operating systems and disclosures, etc., and the modem processor mainly processes wireless communications. It may be understood that the above mentioned modem processor may also not be integrated into the CPU.

The memory may be used to store software programs and modules, and the CPU executes various functional disclosures and processes data by running the software programs and modules stored in the memory. The memory may mainly include a program storage area and a data storage area, where the program storage area can store an operating system, an disclosure required by at least one function (such as a sound play function, image play function, etc.); the data storage area can store data created during the use of the electronic device, or the like. In addition, the memory may include a high-speed random access memory, and may also include a non-volatile memory, such as at least one disk storage device and a flash memory device, or other volatile solid-state storage devices. Accordingly, the memory may also include a memory controller to provide an access by the CPU to the memory.

The travel mechanism 502 is electrically connected to the control module 501 for adjusting the travel speed and direction of the robotic lawn mower in response to control signals transmitted by the control module 501 to implement the self-moving function of the robotic lawn mower.

The cutting module 503 is electrically connected to the control module 501 and is configured to adjust the height and speed of the cutter disc in response to the control signals transmitted by the control module to carry out the mowing operation.

The power source 504 may be logically connected to the control module 501 by means of a power management system, so as to implement the functions, such as charging management, discharging management and power consumption management, by means of the power management system. The power source 504 may also include any of more than one DC or AC power source, a recharging system, a power failure detection circuit, a power converter or an inverter, and a power status indicator, etc.

Although not shown, the robotic lawn mower may also include a communication module, a sensor module, a prompt module, etc., which will not be repeated here.

The communication module is configured to transmit and receive signals during transmitting and receiving information, and to enable signal transmitting and receiving between a user device and a base station or a server by means of establishing a communication connection with the user device, the base station or the server.

The sensor module is configured to collect internal or external environmental information, and to feed the collected environmental data back to the control module for making a decision, thereby achieving the functions of precise positioning and intelligent obstacle avoidance of the robotic lawn mower. Optionally, the sensor may include an ultrasonic sensor, an infrared sensor, an impact sensor, a rain sensor, a LIDAR sensor, an inertial measurement unit, a tachometer, an image sensor, a position sensor and other sensors, which are not limited.

The prompt module is configured to indicate the current operating status of the robotic lawn mower to the user. In this scheme, the prompt module includes, but is not limited to, an indicator light, a buzzer, and the like. For example, the robotic lawn mower can indicate to the user the current status of the power source, the operating status of an electric motor, the operating status of the sensor, etc. by means of the indicator light. For another example, if a malfunction or theft of the robotic lawn mower is detected, an alert can be provided by the buzzer.

Particularly, in this embodiment, the processor of the control module 501 may load executable files corresponding to the processes of one or more disclosures into the memory, and the disclosures stored in the memory is run by the processor in accordance with the following instructions so as to achieve various functions:
determining a current mowing direction of a robotic lawn mower according to a historical mowing direction in response to a mowing trigger request for the robotic lawn mower, obtaining a preset grass region to be mowed, generating a mowing route following parallel arcuate paths pattern for traveling in the current mowing direction based on the grass region to be mowed, and a mowing mode and the current mowing direction of the robotic lawn mower, and controlling the robotic lawn mower to perform a mowing operation based on the mowing route following parallel arcuate paths pattern.

For the implementation of the above various operations, reference may be made to the foregoing embodiments, which will not be repeated here.

In the embodiment of the present disclosure, a current mowing direction of a robotic lawn mower is determined according to a historical mowing direction in response to a mowing trigger request for the robotic lawn mower, where the current mowing direction is different from the historical mowing direction, then a preset grass region to be mowed is obtained, and then a mowing route following parallel arcuate paths pattern for traveling in the current mowing direction is generated based on the grass region to be mowed, and the mowing mode and the current mowing direction of the robotic lawn mower, and finally the robotic lawn mower is controlled to perform the mowing operations based on the mowing route following parallel arcuate paths pattern. In the mowing solution provided by the present disclosure, the current mowing direction that is different from the historical mowing direction is determined such that the cutting height of the lawn is flatter, avoiding the problem of multiple repetitive mowing routes impairing the lawn. In addition, a mowing route following parallel arcuate paths pattern is generated based on the grass region to be mowed, the mowing mode and the current mowing direction, the robotic lawn mower is subsequently controlled according to the mowing route following parallel arcuate paths pattern to perform the mowing operation, which can reduce the problem of missing mowing. It can be seen therefrom that the embodiments of the present disclosure can increase the coverage of the working area and the mowing efficiency.

In the embodiment of the present disclosure, an initial mowing direction is determined in response to a mowing trigger request for a robotic lawn mower, then a preset grass region to be mowed is obtained, and then a mowing route following parallel arcuate paths pattern for traveling in the current mowing direction is generated based on the grass region to be mowed, and the mowing mode of the robotic lawn mower and the initial mowing direction, and finally the robotic lawn mower is controlled to perform the mowing operation based on the mowing route following parallel arcuate paths pattern. In the mowing solution provided by the present disclosure, a mowing route following parallel arcuate paths pattern is generated based on the grass region to be mowed, the mowing mode and the initial mowing direction, and the robotic lawn mower is subsequently controlled according to the mowing route following parallel arcuate paths pattern to perform the mowing operation, which can reduce the problem of missing mowing. It can be seen therefrom that the embodiments of the present disclosure can increase the coverage of the working area and the mowing efficiency.

Those of ordinary skill in the art will appreciate that all or some of the steps of the various methods of the foregoing embodiments may be completed by the instructions, or be completed by controlling associated hardware by means of the instructions which may be stored in a computer-readable storage medium and loaded and executed by the processor.

To this end, an embodiment of the present disclosure provides a storage medium storing a plurality of instructions which can be loaded by a processor to cause the steps of any of the mowing methods provided in the embodiments of the present disclosure to be carried out. For example, the instructions may cause the following steps to be carried out:
determining a current mowing direction of a robotic lawn mower according to a historical mowing direction in response to a mowing trigger request for the robotic lawn mower, obtaining a preset grass region to be mowed, generating a mowing route following parallel arcuate paths pattern along the current mowing direction based on the grass region to be mowed, and a mowing mode and the current mowing direction of the robotic lawn mower, and controlling the robotic lawn mower to perform a mowing operation based on the mowing route following parallel arcuate paths pattern.

For the implementation of the above various operations, reference may be made to the foregoing embodiments, which will not be repeated here.

The storage medium may include a read only memory (ROM), a random access memory (RAM), a magnetic disk or an optical disk, and the like.

Thanks to the instructions stored in the storage medium, the steps of any of the mowing methods provided in the embodiments of the present disclosure can be carried out, and the benefits achievable by any of the mowing methods provided in the embodiments of the present disclosure can thus be achieved. See the foregoing embodiments for details, which will not be repeated here.

The mowing method and apparatus, the robotic lawn mower and the storage medium provided in the embodiments of the present disclosure are described in detail above, and the principles and implementations of the present disclosure are set forth by way of specific examples herein. The descriptions of the foregoing embodiments are merely intended to facilitate understanding of the method according to the present disclosure and the core idea thereof. In addition, for those skilled in the art, changes may be made to the specific implementations and disclosure range based on the idea of the present disclosure. In conclusion, the contents of this specification should not be construed as a limitation to the present disclosure.

What is claimed is:

1. A mowing method, comprising:
determining a current mowing direction of a robotic lawn mower according to a historical mowing direction in response to a mowing trigger request for the robotic lawn mower, the current mowing direction being different from the historical mowing direction;
obtaining a preset grass region to be mowed;
generating a mowing route following parallel arcuate paths pattern for traveling in the current mowing direction based on the preset grass region to be mowed, and a mowing mode and the current mowing direction of the robotic lawn mower; and
controlling the robotic lawn mower to perform a mowing operation based on the mowing route following the parallel arcuate paths pattern.

1. The mowing method according to claim 1, wherein the current mowing direction is a direction for the N^{th} mowing, wherein N is an integer greater than 2, the historical mowing direction is a direction for the N−1^{th} mowing, and determining the current mowing direction of the robotic lawn mower according to the historical mowing direction comprises:
obtaining a preset deflection strategy and a historical mowing information, the preset deflection strategy carrying a first deflection direction and a first deflection angle;
calculating a target deflection angle based on the historical mowing information and the first deflection angle; and
determining the direction for the N^{th} mowing by the robotic lawn mower based on the first deflection direction, the target deflection angle and the direction for the N−1^{th} mowing.

2. The mowing method according to claim 1, wherein the historical mowing direction is an initial mowing direction, and determining the current mowing direction of the robotic lawn mower according to the historical mowing direction comprises:
obtaining a preset deflection strategy, the preset deflection strategy carrying a second deflection direction and a second deflection angle; and
determining the current mowing direction of the robotic lawn mower based on the second deflection direction, the second deflection angle and the initial mowing direction.

3. The mowing method according to claim 1, wherein generating the mowing route following the parallel arcuate paths pattern along the current mowing direction of the robotic lawn mower based on the preset grass region to be mowed, and the mowing mode and the current mowing direction of the robotic lawn mower comprises:
extracting a swath parameter of the robotic lawn mower from the mowing trigger request;
determining a mower turn-around point based on mowing boundaries of the grass region to be mowed, and the mowing mode, the swath parameter and the current mowing direction of the robotic lawn mower; and
generating the mowing route following the parallel arcuate paths pattern for traveling in the current mowing direction according to a current mowing position and the mower turn-around point.

4. The mowing method according to claim 4, wherein generating the mowing route following the parallel arcuate paths pattern along the current mowing direction according to the current mowing position comprises:
obtaining an isolated area in the grass region to be mowed;
determining route turning points based on the mowing mode of the robotic lawn mower, isolation boundaries of the isolated area, and the current mowing direction; and
generating the mowing route following parallel arcuate paths pattern along the current mowing direction according to the current mowing position, the route turning points and the mowing boundaries of the grass region to be mowed.

5. The mowing method according to claim 5, wherein generating the mowing route following the parallel arcuate paths pattern along the current mowing direction according to the current mowing position, the route turning points and the mowing boundaries of the preset grass region to be mowed comprises:
generating a reference mowing route along the current mowing direction according to the current mowing position, the mowing mode and the mowing boundaries of the grass region to be mowed, the reference mowing route comprising a plurality of reference mowing paths;
adjusting the plurality of reference mowing paths according to the route turning points and the mowing mode so as to obtain mowing paths; and
obtaining the mowing route following the parallel arcuate paths pattern along the current mowing direction by connecting the mowing paths.

6. The mowing method according to claim 4, wherein the method further comprises:
detecting a current operating mode;
when it is detected that the operating mode is a simplex mode, generating the mowing route following the parallel arcuate paths pattern along the current mowing direction according to the current mowing position; and
when it is detected that the operating mode is a duplex mode, generating a first mowing route along the current mowing direction according to the current mowing position, and generating a second mowing route that intersects the first mowing route with an end of the first mowing route as a reference, wherein the first mowing route and the second mowing route are both mowing route following the parallel arcuate paths patterns.

7. The mowing method according to claim 7, wherein the direction of the first mowing route and the direction of the second mowing route are perpendicular to each other.

8. A mowing apparatus, comprising:
a determination circuit is configured to determine a current mowing direction of a robotic lawn mower according to a historical mowing direction in response to a mowing trigger request for the robotic lawn mower, the current mowing direction being different from the historical mowing direction;
an obtaining circuit is configured to obtain a preset grass region to be mowed;
a generation circuit is configured to generate a mowing route following parallel arcuate paths pattern for traveling in the current mowing direction based on the grass region to be mowed, and a mowing mode and the current mowing direction of the robotic lawn mower; and
a control circuit is configured to control the robotic lawn mower to perform a mowing operation based on the mowing route following the parallel arcuate paths pattern.

9. The mowing apparatus according to claim 9, wherein the current mowing direction is a direction for the N^{th} mowing, wherein N is an integer greater than 2, the historical mowing direction is a direction for the N−1^{th} mowing, and determine the current mowing direction of the robotic lawn mower according to the historical mowing direction comprises:
obtain a preset deflection strategy and a historical mowing information, the preset deflection strategy carrying a first deflection direction and a first deflection angle;
calculate a target deflection angle based on the historical mowing information and the first deflection angle; and
determine the direction for the N^{th} mowing by the robotic lawn mower based on the first deflection direction, the target deflection angle and the direction for the N−1^{th} mowing.

10. The mowing apparatus according to claim 9, wherein the historical mowing direction is an initial mowing direction, and determine the current mowing direction of the robotic lawn mower according to the historical mowing direction comprises:
obtain a preset deflection strategy, the preset deflection strategy carrying a second deflection direction and a second deflection angle; and
determine the current mowing direction of the robotic lawn mower based on the second deflection direction, the second deflection angle and the initial mowing direction.

11. The mowing apparatus according to claim 9, wherein generate the mowing route following the parallel arcuate paths pattern along the current mowing direction of the robotic lawn mower based on the preset grass region to be mowed, and the mowing mode and the current mowing direction of the robotic lawn mower comprises:
extract a swath parameter of the robotic lawn mower from the mowing trigger request;
determine a mower turn-around point based on mowing boundaries of the grass region to be mowed, and the mowing mode, the swath parameter and the current mowing direction of the robotic lawn mower; and
generate the mowing route following the parallel arcuate paths pattern for traveling in the current mowing direction according to a current mowing position and the mower turn-around point.

12. The mowing apparatus according to claim 12, wherein generate the mowing route following the parallel arcuate paths pattern along the current mowing direction according to the current mowing position comprises:
obtain an isolated area in the grass region to be mowed;
determine route turning points based on the mowing mode of the robotic lawn mower, isolation boundaries of the isolated area, and the current mowing direction; and
generate the mowing route following parallel arcuate paths pattern along the current mowing direction according to the current mowing position, the route turning points and the mowing boundaries of the grass region to be mowed.

13. The mowing apparatus according to claim 13, wherein generating the mowing route following the parallel arcuate paths pattern along the current mowing direction according to the current mowing position, the route turning points and the mowing boundaries of the preset grass region to be mowed comprises:
generate a reference mowing route along the current mowing direction according to the current mowing position, the mowing mode and the mowing boundaries of the grass region to be mowed, the reference mowing route comprising a plurality of reference mowing paths;
adjust the plurality of reference mowing paths according to the route turning points and the mowing mode so as to obtain mowing paths; and
obtain the mowing route following the parallel arcuate paths pattern along the current mowing direction by connecting the mowing paths.

14. A robotic lawn mower, comprising a memory, a processor, and a computer program stored on the memory, wherein the computer program, when being executed by the processor, carries out the steps of the mowing method, wherein the mowing method comprising:
determining a current mowing direction of a robotic lawn mower according to a historical mowing direction in response to a mowing trigger request for the robotic lawn mower, the current mowing direction being different from the historical mowing direction;
obtaining a preset grass region to be mowed;
generating a mowing route following parallel arcuate paths pattern for traveling in the current mowing direction based on the preset grass region to be mowed, and a mowing mode and the current mowing direction of the robotic lawn mower; and
controlling the robotic lawn mower to perform a mowing operation based on the mowing route following the parallel arcuate paths pattern.

15. The robotic lawn mower according to claim 15, wherein the current mowing direction is a direction for the N^{th} mowing, wherein N is an integer greater than 2, the historical mowing direction is a direction for the N−1^{th} mowing, and determining the current mowing direction of the robotic lawn mower according to the historical mowing direction comprises:
obtaining a preset deflection strategy and a historical mowing information, the preset deflection strategy carrying a first deflection direction and a first deflection angle;
calculating a target deflection angle based on the historical mowing information and the first deflection angle; and
determining the direction for the N^{th} mowing by the robotic lawn mower based on the first deflection direction, the target deflection angle and the direction for the N−1^{th} mowing.

16. The robotic lawn mower according to claim 15, wherein the historical mowing direction is an initial mowing direction, and determining the current mowing direction of the robotic lawn mower according to the historical mowing direction comprises:
obtaining a preset deflection strategy, the preset deflection strategy carrying a second deflection direction and a second deflection angle; and
determining the current mowing direction of the robotic lawn mower based on the second deflection direction, the second deflection angle and the initial mowing direction.

17. The robotic lawn mower according to claim 15, wherein generating the mowing route following the parallel arcuate paths pattern along the current mowing direction of the robotic lawn mower based on the preset grass region to be mowed, and the mowing mode and the current mowing direction of the robotic lawn mower comprises:
extracting a swath parameter of the robotic lawn mower from the mowing trigger request;
determining a mower turn-around point based on mowing boundaries of the grass region to be mowed, and the mowing mode, the swath parameter and the current mowing direction of the robotic lawn mower; and
generating the mowing route following the parallel arcuate paths pattern for traveling in the current mowing direction according to a current mowing position and the mower turn-around point.

18. The robotic lawn mower according to claim 18, wherein generating the mowing route following the parallel arcuate paths pattern along the current mowing direction according to the current mowing position comprises:
obtaining an isolated area in the grass region to be mowed;
determining route turning points based on the mowing mode of the robotic lawn mower, isolation boundaries of the isolated area, and the current mowing direction; and
generating the mowing route following parallel arcuate paths pattern along the current mowing direction according to the current mowing position, the route turning points and the mowing boundaries of the grass region to be mowed.

19. The mowing method according to claim 19, wherein generating the mowing route following the parallel arcuate paths pattern along the current mowing direction according to the current mowing position, the route turning points and the mowing boundaries of the preset grass region to be mowed comprises:
generating a reference mowing route along the current mowing direction according to the current mowing position, the mowing mode and the mowing boundaries of the grass region to be mowed, the reference mowing route comprising a plurality of reference mowing paths;
adjusting the plurality of reference mowing paths according to the route turning points and the mowing mode so as to obtain mowing paths; and
obtaining the mowing route following the parallel arcuate paths pattern along the current mowing direction by connecting the mowing paths.
